(19) United States
(12) Patent Application Publication
(10) Pub. No.: US 2021/0359995 A1
(43) Pub. Date: Nov. 18, 2021

(54) SECURE ACCESS CONTROL

(71) Applicants: Alex Dorrell, West Chester, PA (US); Moeez Ahmed, Blue Bell, 95 (US)

(72) Inventors: Alex Dorrell, West Chester, PA (US); Moeez Ahmed, Blue Bell, 95 (US)

(73) Assignee: Unisys Corporation, Blue Bell, PA (US)

(21) Appl. No.: 16/872,698

(22) Filed: May 12, 2020

(51) Int. Cl. H04L 29/06; G07C 9/00

(52) U.S. Cl. CPC H04L 63/10; H04L 63/0428; H04L 2463/082; H04L 63/0861; G07C 9/00571; H04L 63/0884

(57) ABSTRACT

An access control system includes an access control device and an authentication system. The access control device has an RFID reader for receiving RFID information and at least one other authentication device for receiving authentication information. The authorization system grants or denies access based on the RFID information and the authentication information. The access control device and authorization system are part of a same secure community of interest. A computer implemented method of granting access to a secure zone includes receiving an RFID information from an access control device; comparing the RFID information to RFID information already stored; if the RFID information does not match the RFID information already stored, sending a deny access code to the access control device; if the RFID information does match the RFID information already stored, requesting authentication information; receiving authentication information; comparing the authentication information to authentication information already stored; if the authentication information does not match the authentication information already stored, sending a deny access code to the access control device; and if the authentication information does match the authentication information already stored, sending a grant access code to the access control device.

### FIELD OF THE DISCLOSURE

The present application relates generally to access control, and more particularly to secure access control using secure endpoints and secure identification methods aimed at physical access control and asset tracking.

### BACKGROUND

Access control to a building is typically provided by an access card, issued to an employee or by presenting a form of identification to a person who determines whether to grant access. Access cards can be lost, stolen or easily transferred to another person. Forms of identification can be forged, lost, stolen, etc. In addition, neither form of access control provides tracking capabilities. Therefore, improvements are desirable to improve the security of access control while also providing a means for tracking assets or people.

### SUMMARY

In a first aspect of the present invention, a system includes an access control system that includes an access control device and an authentication system. The access control device has an RFID reader for receiving RFID information and at least one other authentication device for receiving authentication information. The authorization system grants or denies access based on the RFID information and the authentication information. The access control device and authorization system are part of a same secure community of interest.

In a second aspect of the present invention, a computer implemented method of granting access to a secure zone is disclosed. The method includes receiving an RFID information from an access control device; comparing the RFID information to RFID information already stored; if the RFID information does not match the RFID information already stored, sending a deny access code to the access control device; if the RFID information does match the RFID information already stored, requesting authentication information; receiving authentication information; comparing the authentication information to authentication information already stored; if the authentication information does not match the authentication information already stored, sending a deny access code to the access control device; and if the authentication information does match the authentication information already stored, sending a grant access code to the access control device.

In a third aspect of the present invention an access control device includes an RFID reader for receiving RFID information; a fingerprint scanner for scanning a fingerprint; and a camera for taking a photo. The access control device captures and sends the RFID information, fingerprint and photo to a remote authorization system for granting or denying access to a secure area.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the disclosed system and methods, reference is now made to the following descriptions taken in conjunction with the accompanying drawings.

FIG. 1 is a block diagram illustrating an encrypted enclave of virtual machines organized into communities-of-interest, according to one embodiment of the present invention;

FIG. 2 is a is a block diagram illustrating a network implementing communities-of-interest, according to one embodiment of the present invention;

FIG. 3 is a block diagram illustrating an enclave included in the network of FIG. 2;

FIG. 4 is a schematic diagram of an access control system, according to one example embodiment of the present invention;

FIG. 5 is a flow diagram of a method for access control, according to an example embodiment of the present invention.

FIG. 6 is a schematic diagram of an access control system, according to another example embodiment of the present invention.

FIG. 7 is a schematic diagram of an access control device, according to an example embodiment of the present invention.

FIG. 8 is a schematic diagram of an access control device, according to another example embodiment of the present invention.

FIG. 9 is a flow diagram of a method for locating an asset, according to one example embodiment of the present invention.

FIG. 10 is a flow diagram of a method for tracking an asset, according to one example embodiment of the present invention.

FIG. 11 is a block diagram illustrating a computer network, according to one example embodiment of the present invention;

FIG. 12 is a block diagram illustrating a computer system, according to one example embodiment of the present invention; and

### DETAILED DESCRIPTION

Access control is used to limit and grant access to buildings, computer terminals and the like. Access control can also be used to log and track assets, such as people. In general, secure access control uses secure endpoints using multiple methods of authentication, including RFID, SSL signature verification, fingerprint scanning, facial recognitions, gestures and the like. Access control can consist of several components including one-touch multi-factor authentication, computer terminal login, access control kiosk, turn-styles for mass authorization, desktop device and a RFID management enmeshed network topology. One-touch multi-factor authentication can include a PIN, one time passphrase, iris scanner, password, voice recognition, fingerprints, facial recognition and the like.

Stealth enterprise security solution from Unisys Corporation of Blue Bell, Pa. can be used to implement features of the present disclosure and in particular to secure access control. Stealth can be used to protect the end to end data communications and make the endpoints go dark on the Internet. As with other Stealth applications, not all endpoints require Stealth protection.

Stealth reduces attack surfaces in an environment by creating dynamic, identity-driven microsegments called communities-of-interest. Micro segmentation is a security strategy that segments a network into smaller elements and manages them with IT security policies. By establishing secure community-of-interest, Stealth separates trusted systems, users and data from the untrusted. It further reduces attack surfaces by encrypting all communication between Stealth protected assets and cloaking the assets from unauthorized users. Micro segmentation divides a physical network into multiple logical micro-segments. Only the resources within the micro segment can see and access one another.

For example, virtual machines executing on one or more servers may each be assigned one or more communities-of-interest. The communities-of-interest may allow an administrator to create logical organizations of virtual machines. A community-of-interest may be defined by a role of the virtual machines in the community-of-interest.

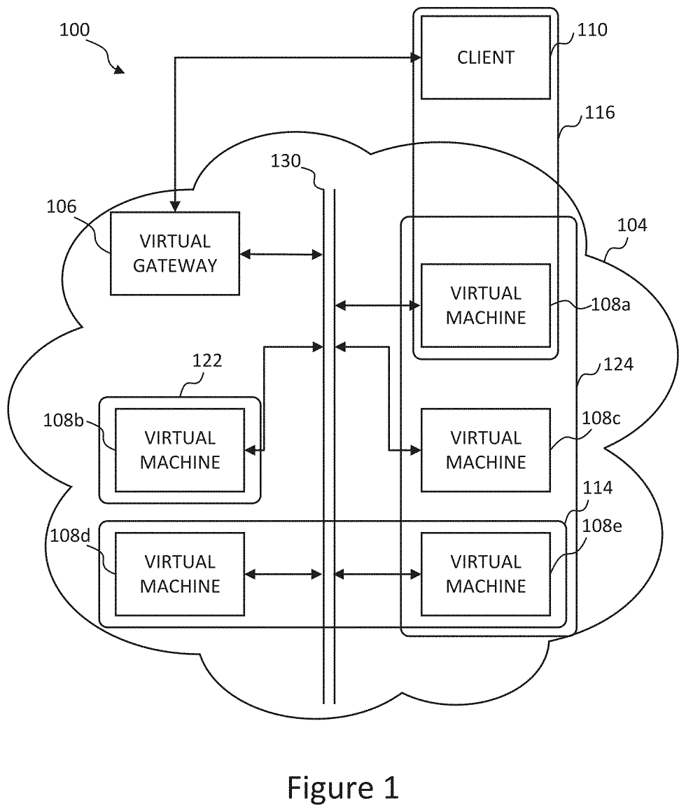

Messages or communications within a community-of-interest are encrypted with a key corresponding to the community-of-interest. In this fashion, messages or communications are cryptographically isolated. FIG. 1 is a block diagram illustrating an encrypted enclave of virtual machines organized into communities-of-interest according to one example embodiment of the present disclosure. A network 100 may include a network bus 130 serving an enclave 104. The bus 130 may couple virtual machines 108a-e within the enclave 104. Each of the virtual machines 108a-e may communicate through encrypted communications carried on the bus 130. A virtual gateway 106 may be coupled to the bus 130 to provide communications from the enclave 104 to external devices, such as a client 110 and/or other public networks, such as the Internet. The client 110 may be a remoted device, such as a personal computer or mobile device. The client 110 may be connected to the virtual gateway 106 through a secured tunnel, such that the communications between the client 110 and the virtual gateway 106 are encrypted similar to the encrypted communications on the bus 130.

The virtual machines 108a-e may be assigned to one or more communities-of-interest. For example, the virtual machines 108a, 108c, and 108e may be assigned to community-of-interest 124. Virtual machines 108d and 108e may be assigned to community-of-interest 114. And, virtual machine 108b may be assigned to community-of-interest 122. And, the virtual machine 108a and the client 110 may be assigned community-of-interest 116.

A virtual machine 108e may be instructed to transmit a message to the virtual machine 108a. For example, software executing on the virtual machine 108e may request data from a database server executing on the virtual machine 108e may request data from a database server executing on the virtual machine 108a. When the virtual machine 108e receives the message destined for the virtual machine 108a, the virtual machine 108e may identify a community-of-interest in common between virtual machine 108e and virtual machine 108a. The community-of-interest 124 may be identified and a key associated with COI 124 may be used to encrypt the message.

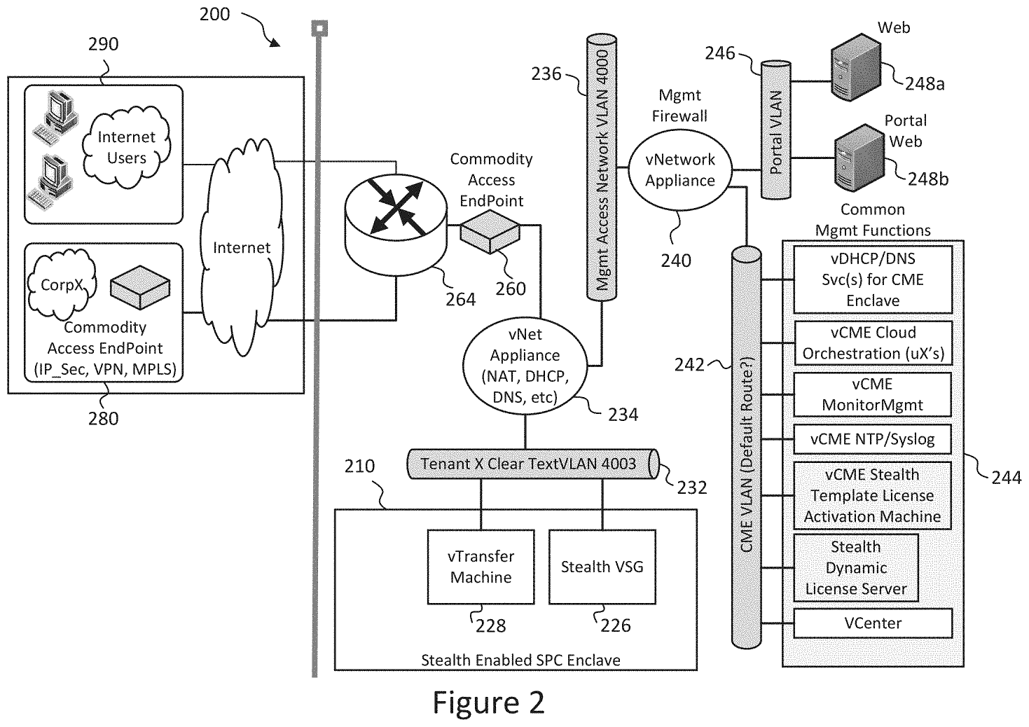

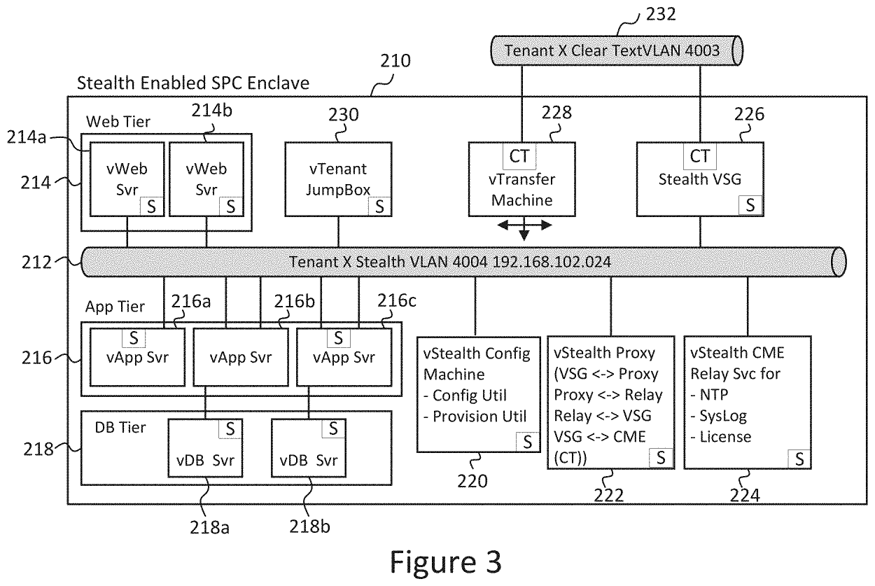

The community-of-interest organization of virtual machines may be implemented in a computer network to provide cryptographic isolation of virtual machines. FIGS. 2 and 3 are block diagrams illustrating a network implementing communities-of-interest according to one embodiment of the disclosure. A network 200 may include an enclave 210. According to one embodiment, the enclave 210 may belong to a single tenant of the network 200. In other embodiments, the enclave 210 may be shared between tenants.

Communities-of-interest may be configured for a web tier 214, an application tier 216, and a database tier 218. The web tier 214 may include a number of web servers 214a-b, the application tier 216 may include a number of application servers 216a-c, and the database tier 218 may include a number of database servers 218a-b. Each of the servers 214a-b, 216a-c, and 218a-b may be a virtual server executing within a virtual machine. Additional communities-of-interest may be defined for infrastructure functions, such as an administrator community-of-interest key COI, a relay COI, an application tier management CO, a database tier management COI, and a jumpbox management COI. The enclave 210 may also include a jumpbox 230, a transfer machine 228, a virtual gateway 226, a relay 224, a proxy 222, and a configuration device 220, which may also be executing in virtual machines.

Membership of the virtual machines in individual COIs are shown as numbered circles. Each circle may represent a different COI, such as the web tier COI. For example, a web tier COI may include the servers 214a-b, the jumpbox 230, and the virtual gateway 226. According to one embodiment, only virtual machines that share a common COI may communicate. When a first virtual machine initiates communication with a second virtual machine, the first virtual machine may search for a common COI between the first and the second virtual machine. If found, a cryptographic session key may be created that is encrypted with a key associated with the common COI. Thus, only a virtual machine that shares the COI key may decrypt the session key. All communication between the two virtual machines may be encrypted and decrypted with the session key. Messages within the enclave 210 may be isolated from the rest of the network 200, because the messages are encrypted with keys that are not available to the rest of the network 200.

For example, a web server virtual machine 214a may be able to communicate with another web server virtual machine 214b, because the virtual machines 214a-b have the web tier COI in common. They may also be able to communicate with application server virtual machines 216a-c, because the machines 214a-b and 216a-c have the application tier COI in common.

Each of the devices within the enclave 210 may be coupled to a bus 212. When a device within the enclave 210 communicates with devices outside the enclave 210, then messages may be handled by the virtual gateway 226, which may be coupled to an unencrypted network 232. According to one embodiment, the virtual gateway 226 may encrypt and/or decrypt messages between the enclave 210 and the unencrypted network 232. The network 232 may couple the enclave 210 to other network appliances 234, such as network address translation (NAT) devices, dynamic host control protocol (DHCP) devices, domain name service (DNS) devices, and the like. The other network appliances 234 may also be executing in virtual machines.

Access to the enclave 210 may be controlled by the virtual gateway 226. Messages passing through the gateway 226 from the unencrypted, or clear-text, network 222 to the enclave 210 may be encrypted and messages in the other direction may be decrypted by the gateway 226. According to one embodiment, messages within the enclave 210 may only be transmitted to a virtual machine that has a COI in common with the gateway 226. Furthermore, the gateway 226 may be configured to filter messages for a COI. The filter may allow an administrator to restrict access based on a message's source and/or destination address and/or port. The enclave 210 may also be isolated from other enclaves (not shown) in the network 200, because only a virtual machine having a common COI with the gateway 226 may communicate outside of the enclave 310.

For example, the web servers 214a-b may be able to communicate through the gateway 226, because the web servers 214a-b share the web tier COI with the gateway 226. In another example, the application servers 216a-c and the database servers 218a-b may have restricted access through the gateway 226, because the gateway 226 may filter messages transmitted in the application COI and the database COI to only provide access to management devices 244.

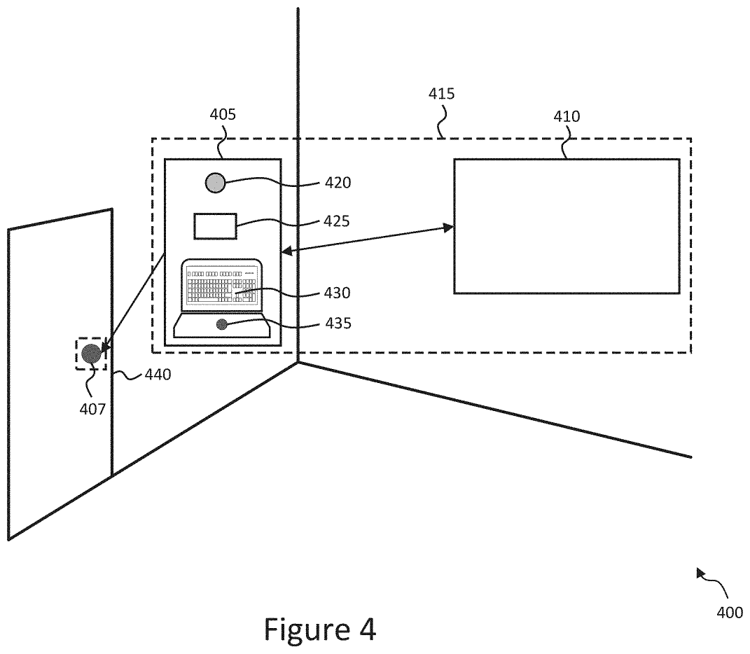

Referring to FIG. 4, an access control system 400 for entry through a locked door is illustrated. The access control system 400, includes an access control device 405, connected to an electronic lock device 407, and an authentication system 410. Preferably, the access control device 405 and the authentication system 410 are secure endpoints, such as Stealth endpoints, and share a common COI 415. In this example, the access control device 405 includes a camera 420, a display 425, a keypad 430 and a RFID/Fingerprint scanner 435. The access control device 405 communicates with the authentication system 410 to authenticate a user attempting to access a locked door 440. Once authentication is verified, the access control device 405 can send an unlock signal to the lock device 407 to unlock the door 440.

Preferably, RFID wristbands are worn by users, such as 13.56 MHz RFID wristbands with signed XML for identification. These wristbands can store up to 1 KB of data and have a read distance between 10 cm and 1 meter. They are waterproof and do not require batteries. The following example XML can be compressed to 965B:

<?xml version=“1.0” encoding=“UTF-8”?>
<id>

<name>Barnaby Marmaduke Aloysius Benjy Cobweb Dartagnan Egbert Felix Gaspar Humbert

lgnatius Jayden Kasper Leroy Maximilian Neddy Obiajulu Pepin Quilliam Rosencrantz
Sexton Teddy Upwood Vivatma Wayland Xyion Yardley Zachary Usansky</name>

<dob>01/01/1987</dob>
<id>10000000000000000000</id>
<uid>100000000000000000</uid>
<signature>C5ZYxnOCkjsdLaBfJ65l6aa72SKl4hVy68/rw+wt7xelD9zPYipipYDwxhlpmvyC

ez6lOEZMsX/alJsWsd9e60B1BK1djg1uso+E/qbV+9yiQwxJfaJ/ot7kggQr1Alv
OlVajlYZlzB85VvaeRHFRuGW3MBKHVZP2Cr2C4lWTnuiywjFuA3iT/ZhGg52T3+r
KbivE+zcmDQ1zoWPhFD3m2G1Bu8ltrhClRv7/vXgwp4L0HfWcR6rVwpVqnoHKiUp
eEBmrWUKyNqP6TaWi7v7xo14Dc0pl/jU/bHmWM3l9kU9d8k0s42Ua8eLDRRWOwgD
cBvmNArQR/xxY373rtb7VzF61Qd/9G2g8QwPgSQWxNBAL5r5SqdTv0Fyn2fPKQPS
l5MmMUcAdd/5z8Juh0vAGrO8citH9yfMVYcmStgThYWLlhMD6BG9CVXN9++vKT8s
GTPrbuooKf7aA8Y6PjrNJZpeO6bnbWaF3O6xP2m2J+leLlL91oJ2clTFiz4gBkEh
yxc6ZCmSnE9l/CUwa+QqYEtRDhvYG68yMl/lBhO8n62U1iXqBeL87jPKl8BMLUQ3
s352zPaZ8OJN4z3cvweKEA/h1xlMJ5cQBMZYlfCXWVAMJfJDbf+YCkHv0BTxRz1m
KtbhChRRJ21CcTfr9nH+9OeQOQ3Co2b+eumpbxG4wXk=</signature>
</id>

Powered RFID wristbands and tags can also be used and can have a read distance of up to 100 meters. They can be set to broadcast at periodic intervals. Access control can also use these wristbands to track people and assets within buildings or other defined areas.

Access is granted to the door 440 through multi-factor authentication with a single touch. Preferably, this includes RFID and SSL signature verification, fingerprint scanning and facial recognition. By placing an RFID reader with the fingerprint scanner 435 and a camera 420, it is possible to quickly perform all three methods at once. The RFID reader 435 reads the information from the wristband of the user as the fingerprint scanner 435 scans the user's fingerprint. The camera 420 take a photo of the user's face while the user is scanning his or her fingerprint. The access control device 405 then communicates this information to the authentication system 410 with the data protected, i.e. by Stealth. For additional security, it is possible to extend access control with additional authentication methods.

All of the biometric data is stored on the authentication system 410 and the access control device 405 does one to one matching. The biometric data is indexed based on the identity stored in the signed XML on the user's RFID wristband. The authentication system 410 does the facial recognition and SSL verification of the signed XML from the wristband. By splitting the verification between the authentication system 410 and the access control device 405, a bad actor cannot get around the access control by hacking into the access control device 405.

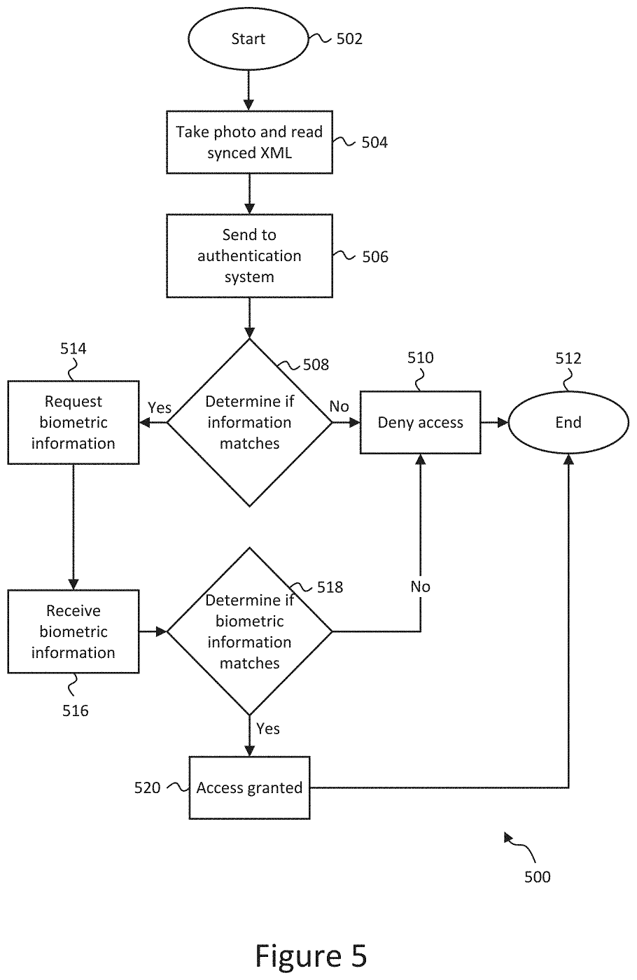

Referring to FIG. 5, a method 500 of authenticating a user is illustrated. The method 500 starts at 502. At 504, the access control device, i.e. the access control device 405 of FIG. 4, reads the signed XML from the user's wristband, scans the user's fingerprint and takes a photo of the user. The access control device sends the XML and photo at 506 to an authentication system, i.e. the authentication system 410 of FIG. 4. At 508, the authentication system determines if the photo and the signed XML match for the user. If the authentication system determines that the information does not match, access is denied at 510 and the method ends at 512.

If the authentication system determines that the information does match, the authentication system requests the biometric data, i.e. the fingerprint, from the access control device at 514 and receives that information at 516. At 518, the authentication system determines if the biometric data matches that stored for the user. If the authentication system determines the data does not match, access is denied at 510 and flow ends at 512. If the authentication system determines the data does match, access is granted at 520 and the method ends at 512. When access is granted 520, the authentication system would send a signal to the access control device to unlock the door. The access control device would then send a signal to the lock device to unlock the door.

A simple PIN (or personal identification number) can also be used for authentication along with a one time passphrase. Iris scanning via an iris scanner could also be used along with voice recognition via a microphone. Gestures could also be used. By layering multiple authentication methods, it becomes increasingly difficult for a bad actor to compromise each and every one of them. A user could give the authentication information under the watch of a security officer who would be able to see if someone was trying to bypass the methods. The goal is to make multi-factored authentication as easy as possible to the end user, while allowing companies or the government to create a variable amount of security.

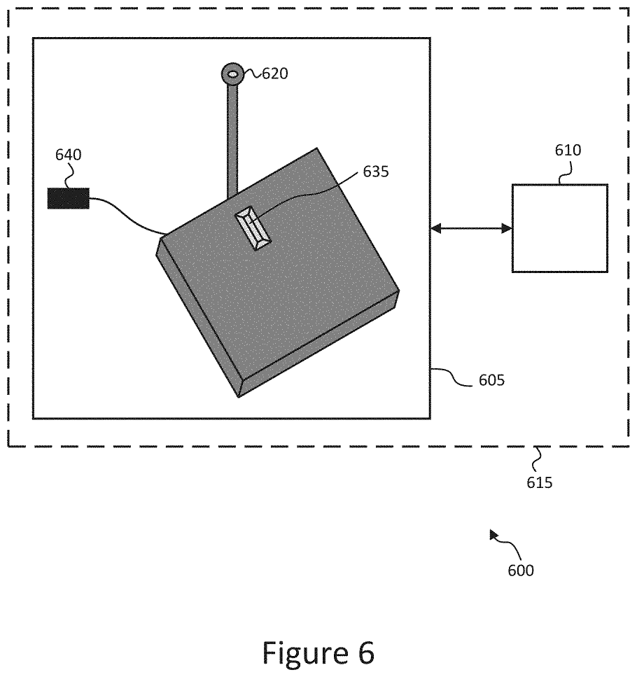

Referring to FIG. 6, an access control system 600 for logging into a terminal is illustrated. The access control system 600, includes an access control device 605 and an authentication system 610. Preferably, the access control device 605 and the authentication system 610 are secure endpoints, such as Stealth endpoints, and share a common COI 615. The access control device 605 can be part of a laptop or computer or a USB accessory as shown. Most laptops come equipped with webcams 620 and fingerprint scanners 635. Using these, it is possible to use the webcam 620 for facial recognition and the fingerprint scanner 635 to scan a user's fingerprint. The RFID could be excluded in this example in favor of a username or a USB RFID reader can be used to perform authorization of users for computers. In absence of a laptop or computer equipped with these accessories, USB devices can be used. The access control device 605 communicates with the authentication system 610 to authenticate a user attempting to access a computer.

Referring back to FIG. 5, a similar method could be used for the device of FIG. 6. If a username or password is used in lieu of the RFID, then the username or password could be passed to the authentication system rather than the signed XML of the RFID.

Kiosks could also be used for access control using the elements of FIGS. 4-6. Kiosks can include ATMs, self service kiosks for embassies for lost passports or visa help, airport check-in, bus/train/subway terminals, movie theaters, self check-out at stores, hotels, etc.

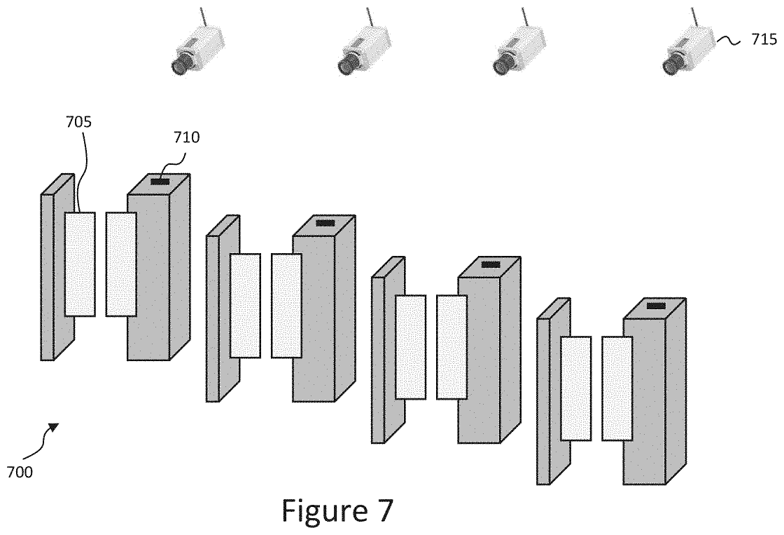

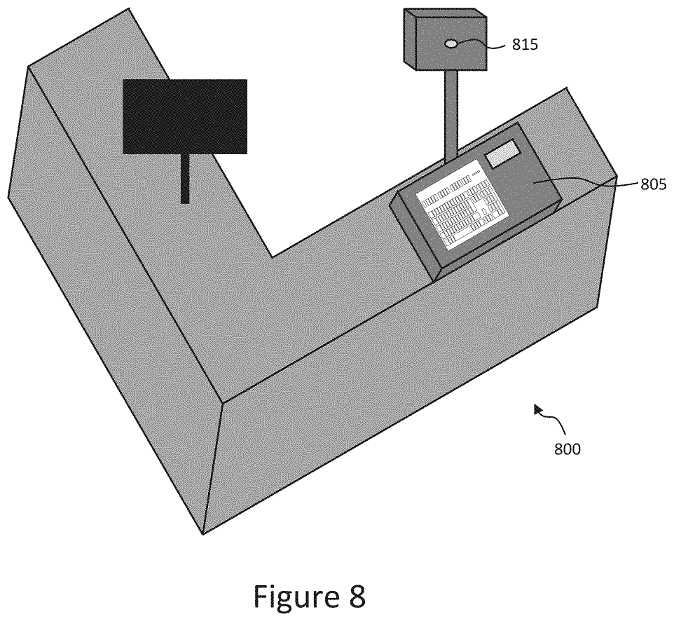

Referring to FIG. 7, an access control device 700 is shown. The turn-style device is a simple way to quickly authenticate large volumes of people. It consists of a turn-style gate 705, an RFID reader and fingerprint scanner 710 and ceiling mounted cameras 715. Referring to FIG. 8, an access control device 800 is illustrated. In this example, the device 800 is used by security offices and includes a fingerprint scanner and RFID scanner 805 and a camera 815. These devices 800 can be used to enroll users in access control, visitor login or check-in for Secure Access Control RFID Area Management Enmeshed Network Topology Offering (SACRAMENTO).

SACRAMENTO is an access control solution to tracking assets, such as people within restricted zones. It uses a mesh network of IOT devices within an area to create a near real-time mapping of RFID tags. Active RFID tags can be set to broadcast every 5 seconds and can be read by any RFID reader within 100 meters.

By creating a mesh network of IOT devices, a 3D map can be created of the area with every tag within the mesh network to see if any person or asset leaves their approved zones and otherwise track its movement. Additionally, tampering can be detected along with behavioral analysis in order to thwart bad actors. “Zones of Interest” can be created with SACRAMENTO. These zones would be similar to COIs in Stealth and would operate on the same principles. Only certain groups of users need to be in certain areas. These zones could be tied into the roles created by Stealth's Enterprise Manager.

Since active RFID tags run on battery power, it may be preferable to issue active RFID wristbands to users and guests on a daily basis. When someone comes in the main entrance to a site secured by SACRAMENTO, they would go through the enrollment/authorization process using a secure access control desktop device. The security officer would then issue them an active RFID wristband tied to that particular user. Each user or guest would only belong in the predefined Zones of Interest. If a user leaves their zone, it would issue an alert to the security officers, who would then be able to track down the user to see why they are not where they are supposed to be. In addition to protecting restricted areas, SACRAMENTO would also be able to ensure that, in the event of an emergency, everyone was safely evacuated.

The tracking protocol works similar to GPS. Each reader takes the UUID of the RFID tracker and the signal strength of the RFID broadcast. It then sends them to a cluster of servers dedicated to tracking assets. The mapping cluster triangulates the signal based off of the known locations of the RFID readers as follows:

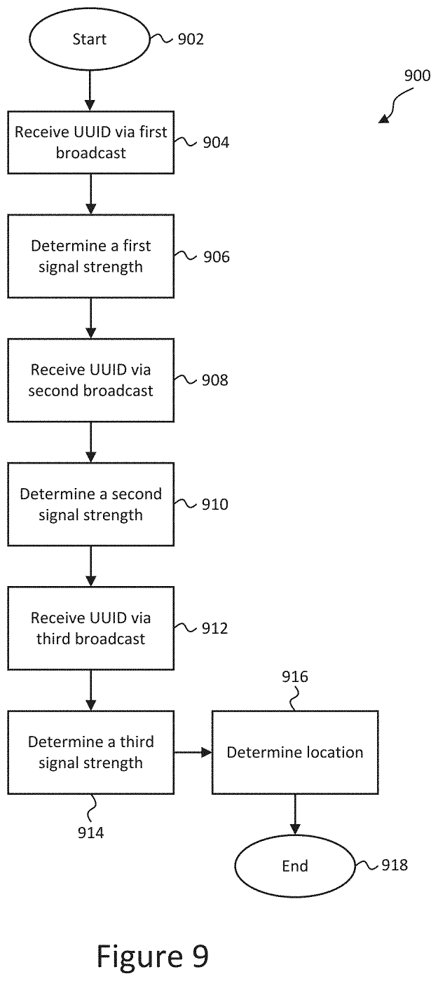

Referring to FIG. 9, a method 900 of locating an RFID tracker is illustrated using the protocol above. The method 900 begins at 902. At 904, a UUID of an RFID tracker is received via a first broadcast. At 906, a first signal strength, for example 39%, of the first broadcast is determined. At 908, the UUID of the RFID tracker is received via a second broadcast. At 910, a second signal strength, for example 84%, of the second broadcast is determined. At 912, the UUID of the RFID tracker is received via a third broadcast. At 914, a third signal strength, for example 72%, of the third broadcast is determined. At 916, the location of the RFID tracker is determined based on the first, second and third signals.

Behavioral analysis can be performed by tracking people and assets over time and by timing the amount of time people spend in each location on a daily basis. A behavioral profile of a person can be created and a security alert issued if the person deviates from his or her profile. Security alerts are warnings sent to the security officers of a site protected by SACRAMENTO when one of several things happen. An alert is not necessarily the results of a bad actor but warrant a security officer to investigate. Security alerts can include an RFID signal being lost (which may be a dead battery or tampering with the device), entering a restricted zone, leaving a restricted zone, too much time spent in a restricted zone, too little movement (may indicate the tracker was removed) or a behavioral analysis alert.

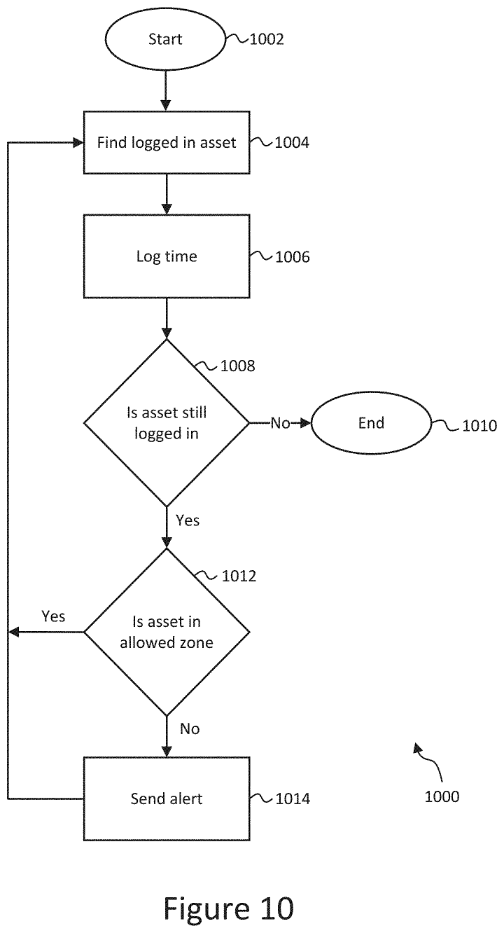

Referring to FIG. 10, a method 1000 of tracking an asset is shown. The method begins at 1002. At 1004, a logged in asset is located. By logged in, it is meant that the user has checked into the secured area and been issue a wristband. At 1006, the of the time of the found location is logged so that changes over time can be monitored. At 1008, the system determines if the asset is still logged in, i.e. the user has not checked out and returned the wristband. If the system determines that asset has checked out, the method ends at 1010. If the system determines the asset is still logged in, flow continues to 1012 to determine if the asset is in the allowed zone(s). If the asset is in the allowed zone(s), flow loops back to 1004 and continues as described above, if the system determines the asset is not in an allowed zone, flow proceeds to 1014 to issue a security alert to a security guard and flow continues to 1004.

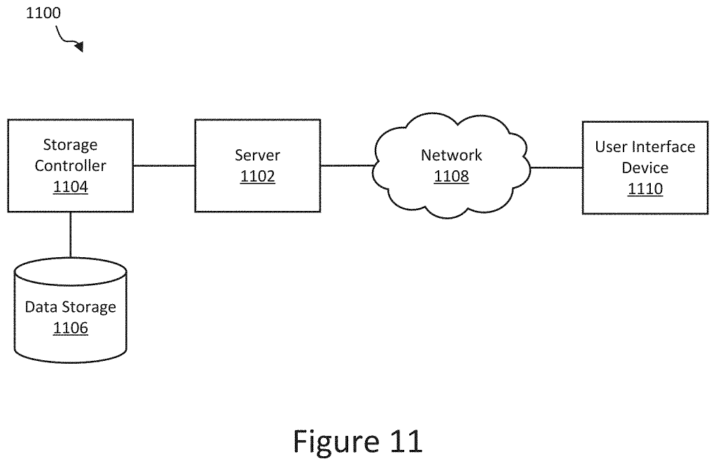

FIG. 11 illustrates one embodiment of a system 1100 for an information system, which may host virtual machines. The system 1100 may include a server 1102, a data storage device 1106, a network 1108, and a user interface device 1110. The server 1102 may be a dedicated server or one server in a cloud computing system. The server 1102 may also be a hypervisor-based system executing one or more guest partitions. The user interface device 1110 may be, for example, a mobile device operated by a tenant administrator. In a further embodiment, the system 1100 may include a storage controller 1104, or storage server configured to manage data communications between the data storage device 1106 and the server 1102 or other components in communication with the network 1108. In an alternative embodiment, the storage controller 1104 may be coupled to the network 1108.

In one embodiment, the user interface device 1110 is referred to broadly and is intended to encompass a suitable processor-based device such as a desktop computer, a laptop computer, a personal digital assistant (PDA) or tablet computer, a smartphone or other a mobile communication device having access to the network 1108. The user interface device 1110 may be used to access a web service executing on the server 1102. When the device 1110 is a mobile device, sensors (not shown), such as a camera or accelerometer, may be embedded in the device 1110. When the device 1110 is a desktop computer the sensors may be embedded in an attachment (not shown) to the device 1110. In a further embodiment, the user interface device 1110 may access the Internet or other wide area or local area network to access a web application or web service hosted by the server 1102 and provide a user interface for enabling a user to enter or receive information.

The network 1108 may facilitate communications of data, such as dynamic license request messages, between the server 1102 and the user interface device 1110. The network 1008 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 1110 accesses the server 1102 through an intermediate sever (not shown). For example, in a cloud application the user interface device 1110 may access an application server. The application server may fulfill requests from the user interface device 1110 by accessing a database management system (DBMS). In this embodiment, the user interface device 1110 may be a computer or phone executing a Java application making requests to a JBOSS server executing on a Linux server, which fulfills the requests by accessing a relational database management system (RDMS) on a mainframe server.

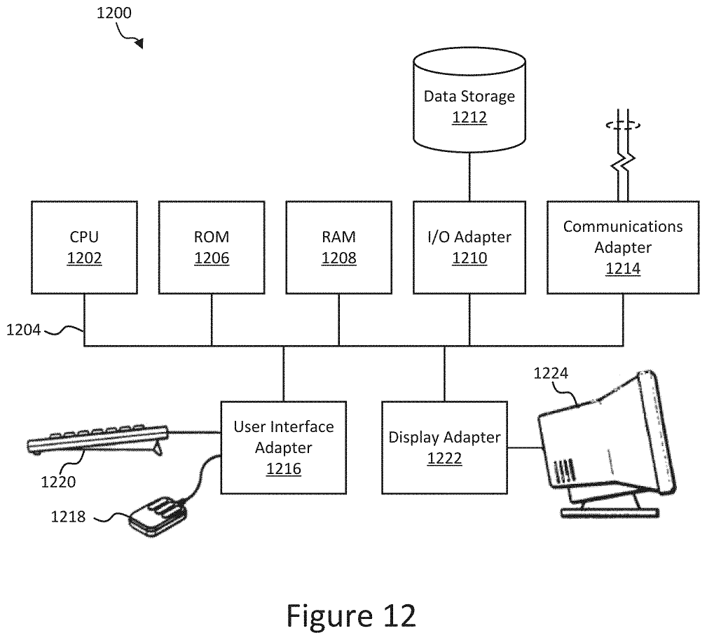

FIG. 12 illustrates a computer system 1200 adapted according to certain embodiments of the server 1102 and/or the user interface device 1110. The central processing unit (“CPU”) 1202 is coupled to the system bus 1104. The CPU 1202 may be a general purpose CPU or microprocessor, graphics processing unit (“GPU”), and/or microcontroller. The present embodiments are not restricted by the architecture of the CPU 1202 so long as the CPU 1202, whether directly or indirectly, supports the operations as described herein. The CPU 1202 may execute the various logical instructions according to the present embodiments.

The computer system 1200 also may include random access memory (RAM) 1208, which may be synchronous RAM (SRAM), dynamic RAM (DRAM), synchronous dynamic RAM (SDRAM), or the like. The computer system 1200 may utilize RAM 1208 to store the various data structures used by a software application. The computer system 1200 may also include read only memory (ROM) 1206 which may be PROM, EPROM, EEPROM, optical storage, or the like. The ROM may store configuration information for booting the computer system 1200. The RAM 1208 and the ROM 1206 hold user and system data, and both the RAM 1208 and the ROM 1206 may be randomly accessed.

The computer system 1200 may also include an input/output (I/O) adapter 1210, a communications adapter 1214, a user interface adapter 1216, and a display adapter 1222. The I/O adapter 1210 and/or the user interface adapter 1216 may, in certain embodiments, enable a user to interact with the computer system 1200. In a further embodiment, the display adapter 1222 may display a graphical user interface (GUI) associated with a software or web-based application on a display device 1224, such as a monitor or touch screen.

The I/O adapter 1210 may couple one or more storage devices 1212, such as one or more of a hard drive, a solid state storage device, a flash drive, a compact disc (CD) drive, a floppy disk drive, and a tape drive, to the computer system 1200. According to one embodiment, the data storage 1212 may be a separate server coupled to the computer system 1200 through a network connection to the I/O adapter 1210. The communications adapter 1214 may be adapted to couple the computer system 1200 to the network 1208, which may be one or more of a LAN, WAN, and/or the Internet. The communications adapter 1214 may also be adapted to couple the computer system 1200 to other networks such as a global positioning system (GPS) or a Bluetooth network. The user interface adapter 1216 couples user input devices, such as a keyboard 1220, a pointing device 1218, and/or a touch screen (not shown) to the computer system 1200. The keyboard 1220 may be an on-screen keyboard displayed on a touch panel. Additional devices (not shown) such as a camera, microphone, video camera, accelerometer, compass, and or gyroscope may be coupled to the user interface adapter 1216. The display adapter 1222 may be driven by the CPU 1202 to control the display on the display device 1224. Any of the devices 1202-1222 may be physical and/or logical.

The applications of the present disclosure are not limited to the architecture of computer system 1200. Rather the computer system 1200 is provided as an example of one type of computing device that may be adapted to perform the functions of a server 1102 and/or the user interface device 1110. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 1200 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

We claim:

1. An access control system comprising:
an access control device having an RFID reader for receiving RFID information and at least one other authentication device for receiving authentication information;
an authorization system for granting or denying access based on the RFID information and authentication information; and
wherein the access control device and authorization system are part of a same secure environment.

2. The access control system of claim 1, wherein the access control device sends the RFID information to the authentication device and the authentication device determines if the RFID information matches stored RFID information.

3. The access control system of claim 2, wherein if the authentication device determines that the RFID information matches stored RFID information, the authentication device then requests the authentication information.

4. The access control system of claim 3, wherein the access control device then sends the authentication information to the authorization system and the authorization system then determines if the authentication information matches stored authentication information and if the authentication information matches stored authentication information, then communicating to the access control system to grant access.

5. The access control system of claim 1, wherein the access control device has a fingerprint scanner for capturing a fingerprint of a user and a camera for capturing a photo of a user and wherein the fingerprint and photo are the authentication information.

6. The access control system of claim 1, wherein the access control device sends the fingerprint and the photo to the authorization system for authentication.

7. The access control system of claim 2, wherein the authorization system compares the fingerprint and the photo to a stored fingerprint and a stored photo already stored at the authorization system to determine if the fingerprint and the photo match the stored fingerprint and stored photo.

8. The access control system of claim 7, wherein if the fingerprint and photo match, communicating to the access control system to grant access.

9. A computer implemented method of granting access to a secure zone, the method comprising:
receiving an RFID information from an access control device;
comparing the RFID information to RFID information already stored;
if the RFID information does not match the RFID information already stored, sending a deny access code to the access control device;
if the RFID information does match the RFID information already stored, requesting authentication information;
receiving authentication information;
comparing the authentication information to authentication information already stored;
if the authentication information does not match the authentication information already stored, sending a deny access code to the access control device; and
if the authentication information does match the authentication information already stored, sending a grant access code to the access control device.

10. The method of claim 9, wherein receiving authentication information includes receiving a fingerprint and a photo of a user.

11. The method of claim 9, wherein comparing the RFID includes comparing the RFID by a remote authorization system.

12. The method of claim 9, wherein requesting authentication information and receiving authentication information includes requesting authentication information from the access control device and receiving authentication information includes receiving at a remote authorization system.

13. The method of claim 12, wherein comparing the authentication information includes comparing by the remote authorization system.

14. The method of claim 12, wherein receiving an RFID includes receiving RFID information by a remote authorization system from an access control device through an encrypted secure environment.

15. An access control device comprising:
an RFID reader for receiving RFID information;
a fingerprint scanner for scanning a fingerprint;
a camera for taking a photo;
wherein the access control device captures and sends the RFID information, fingerprint and photo to a remote authorization system for granting or denying access to a secure area.

16. The access control device of claim 15, wherein the access control device is connected to an electronic lock mechanism

17. The access control device of claim 15, wherein the access control device and remote authorization system are part of a same secure community of interest.

18. The access control device of claim 17, wherein the access control device and remote authorization system both have security applications installed.

19. The access control device of claim 18, wherein the security application is Stealth.

20. The access control device of claim 15, wherein the access control device has a USB connection.
